(19) United States
(12) Patent Application Publication
(10) Pub. No.: US 2003/0081826 A1
(43) Pub. Date: May 1, 2003

(54) Tilted scan for Die-to-Die and Cell-to-Cell detection

(75) Inventors: Jacob Karin, Ramat Gan (IL); Arie Shahar, Moshav Magshimim (IL); Gilad Golan, Rishon Le-Zion (IL)

Correspondence Address: DR. MARK FRIEDMAN LTD., C/O BILL POLKINGHORN, DISCOVERY DISPATCH, 9003 FLORIN WAY, UPPER MARLBORO, MD, 20772, US

(73) Assignee: Tokyo Seimitsu (Israel) Ltd.

(21) Appl. No.: 10/193,113

(22) Filed: Jul. 12, 2002

Related U.S. Application Data
(60) Provisional application No. 60/330,680, filed on Oct. 29, 2001.

(51) Int. Cl. G06K 9/00

(52) U.S. Cl. 382/151

(57) ABSTRACT

A method to scan a surface having a periodic pattern using a scanner. The periodic pattern has a first direction of periodicity having a periodic length. The scanner is configured to produce an image having a plurality of pixels, each of the pixels having a pixel origin. The method includes the steps of positioning the first direction of periodicity of the periodic pattern at an angle relative to the scanning direction of the scanner and scanning the surface by generating relative movement between the scanner and the surface.

This application claims the benefit of U.S. Provisional Application No. 60/330,680 filed Oct. 29, 2001.

### FIELD AND BACKGROUND OF THE INVENTION

The present invention relates to a method of scanning and, in particular, it concerns a method for inspecting silicon wafers used in the Integrated Circuits (IC) industry.

Inspection for defects is usually based on methods of comparison. These methods are divided into two techniques that are known in the art.

The first technique is based on a comparison between a pattern of a region under inspection with a reference pattern that represents an ideal defect-free pattern. According to this technique the reference pattern is saved in a memory and then retrieved during the comparison process. In a situation where the area under inspection is big or the inspection requires high resolution or when both criteria are applicable, the memory size needed for storing the reference pattern is very large. In such a case, the memory is too expensive to be used for commercial purposes and the second inspection technique may be used under certain conditions.

The second technique is useful only when the pattern consists of periodic fragments or even periodic structures of sub-fragments at the regions of the basic fragments. In this case, a comparison is made between three fragments or three sub-fragments which, in relation to silicon wafers are known as dies and cells, respectively. Three-fragment comparison is needed to identify the fragment and the defect location within the identified fragment and not just to detect the existence of a defect without the ability to indicate the exact location of the defect. Three-fragment comparison is performed by comparing the fragment under inspection with two adjacent fragments. Statistically, it is assumed that there is a very low probability that a defect will repeat itself at the same position in two other fragments. Therefore, a defect is defined as a deviation that appears twice in the two comparisons and the fragment that contains the defect is the one that differs from the other two fragments.

The comparison is made between two digital images acquired under the same electrical and optical conditions. In other words the electrical gain, signal to noise ratio, optical magnification and imaging quality are substantially the same. Each image under comparison is constructed from a matrix of pixels. Each pixel is characterized by its location and its gray-level value. Two images under comparison are compared on a pixel by pixel basis or a superpixel by superpixel basis. A superpixel by superpixel comparison is a comparison of pixel groups, for example, comparing an average over nine adjacent pixels to another similar group. In other words, the pixels (or the superpixels) corresponding to the same location in each image are compared. A deviation occurs when the difference in gray-level value between the two pixels under comparison is greater than a predetermined threshold value.

Conventional line-scan cameras consist of an array of pixels that view a corresponding line on the surface under inspection. Each pixel views its corresponded area according to the optical magnification of the optical system. The area on the surface under inspection that is viewed by each pixel is known as “pixel size”. Scanning of the surface under inspection is performed by introducing relative movement between the line-scan camera and the surface under inspection along a direction that is perpendicular to the extended direction of the pixel-array. Accordingly, the pixel size along the scan direction is linked to the velocity of the relative movement of the camera and the surface under inspection and to the exposure time of the camera. The pixel size perpendicular to the scan direction is not affected by the relative motion of the camera and the surface under inspection. Therefore, the pixel size perpendicular to the scan direction is known as having a static pixel size and is determined by the optical properties of the imaging system. Therefore, the pixel size along the scan direction can be adjusted by adjusting either one or both of the velocity of the relative movement of the camera and the surface under inspection and the integration time-period of the camera.

The ability to adjust the pixel size along the scan direction is an important feature of the camera when performing the three-fragment comparison method for detecting defects. The ability to adjust the pixel size is critical for the three-fragment comparison method. This is because the comparison between two given images should be performed when the images are aligned without any shift between them. In other words, any given point in one of the images should be located at substantially the same point in a pixel as the corresponding point in the second image. This is to enable accurate and meaningful pixel to pixel comparison when comparing pixels of two different images. When performing Die-to-Die or Cell-to-Cell comparison there should be no shift between the compared images of the fragments or sub-fragments. Images acquired by a line-scan camera may be shifted when the length of the periodic fragments along the scan direction is not an integer multiple of the pixel size along the scan direction. In such a situation, there is a sub-pixel shift between the images and this may lead to false defect detection. Therefore, the ability to adjust the pixel size along the scan direction allows matching of the length of the periodic fragments along the scan direction to an integer multiple of the pixel size along the scan direction. Therefore, there will be no shift between the two images of two adjacent fragments under comparison, resulting in avoiding false defects. Therefore, line-scan cameras are very effective in eliminating problems associated with image shift. However, line-scan cameras cannot perform high resolution scanning with high throughput for the following reasons. To obtain high throughput, the relative movement between the camera and the surface under inspection must be high. However, the sensitivity of the camera requires a certain integration time-period for certain optical conditions. Therefore, the pixel size along the scan direction must increase with the throughput, resulting in resolution degradation. To avoid the linkage between high throughput and resolution degradation, a Time Delay Integration (TDI) camera is used.

A TDI camera is similar to a line scan camera, but instead of having a single pixel array, it has multiple pixel arrays or lines. Moreover, while a line-scan camera evacuates its electrical charge each cycle, a TDI camera quickly transfers the integrated charge from each pixel at each line to its corresponding pixel at the following line. At the last array, the integrated charge is evacuated out of the camera, in a serial mode, at a faster rate than a line-scan camera. This fast evacuation is typically achieved by using several channels simultaneously in parallel. All this activity is performed for each cycle time-period of the camera. The speed of relative movement of the camera and the surface under inspection is adjusted such that during a cycle time-period the relative movement is equal to a pixel size. A first pixel array that is viewing a certain region during an integration time-period will transfer its charge to an adjacent second pixel array. The second pixel array will start its integration at the following cycle time-period immediately after the charge transmission from the first pixel array is complete. Before integration, the second pixel array is aligned to view the exact region viewed by the first pixel array at the previous clock cycle. In this manner, each pixel array will view the same region during successive integration time-periods. Therefore, the charge produced by the radiation collected from the same region at each integration time-period in each pixel array is transferred from array to array and is accumulated. When this accumulated charge reaches the last pixel array of the camera, the accumulated charge value is equal to the sum of the charge produced at each pixel array of the TDI camera. This accumulated charge is evacuated out of the camera in serial mode, as described above.

Accordingly, it is clear that a TDI camera actually operates like a line-scan camera, but the sensitivity of a TDI camera is higher by a factor equal to the number of lines in the camera. The high sensitivity of the TDI breaks the linkage between high throughput and resolution degradation that exists with a line-scan camera. However, a TDI camera suffers from a severe limitation of a fixed pixel size. It is impossible to adjust the pixel size of a TDI camera without causing dramatic degradation in resolution. The high sensitivity of resolution to pixel size is due to the multiple integration of the same region by the different multiple lines of the TDI camera. The multiple integration should be performed at the correct position for each line. This can only be done if the pixel size along the scan direction is equal to the fixed pixel size. If this condition is not fulfilled, there is an accumulated error that increases with the number of lines in the camera.

Reference is now made to FIG. 1a, which is a prior art illustration of an image 10 acquired by scanning a periodic pattern with a TDI camera. Image 10 is an image grabbed by a frame grabber and includes multiple pixels 12. Since a TDI camera, except for the multiple delayed integration that only increases the camera sensitivity, operates in the same conventional way as a line-scan camera, image 10 is acquired by multiple pixel arrays 14 moving in a scan direction 16. The periodic pattern is made up of periodic fragments. Multiple crosses 18 schematically indicate the start and end regions of the periodic fragments. Each fragment has a length 20 in a direction of periodic repetition. It has been assumed that any gap that may exist between periodic fragments is part of a periodic fragment.

In the three-fragment comparison method, the pixels that are compared are pixels that relate to the same position in a fragment, but belong to two different, typically adjacent, fragments. For example: a pixel 22 and a pixel 24. Therefore, when scan direction 16 is oriented along the direction of periodic repetition of the fragments and length 20 is an integer multiple of the size of pixels 12 in the scan direction 16, then comparison of pixel 22 and pixel 24 provides meaningful results. The situation illustrated in FIG. 1a is an ideal situation since length 20 is exactly an integer number of pixels 12. Such a situation is unlikely to happen and usually the situation is not like this.

A more realistic situation is schematically shown in FIG. 1b, which shows a grabbed image 30 produced by a TDI camera. Image 30 includes multiple pixels 32. Image 30 is acquired by multiple pixel arrays 34 moving in a scan direction 36. Scan direction 36 is oriented along a direction of periodic repetition of the fragments of image 30. Multiple crosses 38 schematically indicate the start and end regions of the periodic fragments. Each periodic fragment has a length 40 in the direction of periodic repetition. Since length 40 is not an integer number of pixels 32 in scan direction 36, two adjacent fragments that have to be compared, such as a fragment 44 and a fragment 46, are shifted by an amount 42 relative to each other with respect to the grid of pixels 32. Therefore, a comparison of pixels such as a pixel 48 and a pixel 50 may lead to false defect detection.

A TDI camera is very attractive for inspecting silicon wafers at high throughput. However, the inability to adjust the pixel size so that the size of the dies or cells is an integer number of pixels introduces a problem of false detection. With reference to die-to-die detection, the die usually includes many pixels and the maximum location deviation of the desired pixel from the necessary pixel location is half a pixel size divided by the number of pixels in the Die. Therefore, the deviation is very small and its effect on the resolution is minor.

The situation is completely different in a detection of defects in cells, especially small cells that only include a few pixels. In this case, the maximum deviation is half a pixel divided by the number of pixels in the cell. Therefore, there is a large maximum deviation between the location of the desired pixel and the location of the actual pixel, thereby causing a dramatic degradation in resolution. Accordingly, it is impossible to use this technique for cell-to-cell inspection.

To overcome the problem an image shift is performed by the necessary amount. This shift is performed mathematically using sub-pixel interpolation. In many situations, the periodic cells include frequencies that are high relative as compared to the image resolution, resulting in under-sampling. Under-sampling causes the results of interpolation to be inaccurate and therefore this mathematical method cannot produce the desired shift for avoiding false detection.

An alternative way to make the cell size equal an integer number of a pixels is to adjust the size of the pixels by varying the optical magnification of the camera using a zoom lens system. This alternative has the disadvantages of reducing the optical quality of the image as well as the additional complexity of the zoom system, which can be especially complex when using a microscope having a lens revolver.

Of most relevance to the present invention are U.S. Pat. No. 6,248,988 to Krantz and U.S. patent application no. 2001/0048521 to Vaez-Iravani. Krantz and Vaez-Iravani teach a rotation of the surface to be scanned. However, in both inventions, the rotation of the surface being scanned relates to the structure of the scanner and the rotation is carried out to increase resolution of the scanner.

Also of relevance to the present invention is U.S. patent application no. 2001/0021015 to Morioka, Hiroshi et al. The application of Morioka, Hiroshi et al also teaches a rotation of the surface to be scanned in order to reduce light noise.

There is therefore a need for an improved defect detection method that reduces defect detection errors when using a camera with a fixed pixel size, such as a TDI camera, by reducing the relative shift between the images of the compared fragments acquired by the camera.

### SUMMARY OF THE INVENTION

The present invention is a method for comparing fragments of a pattern consisting of periodic fragments.

According to the teachings of the present invention there is provided, a method to scan a surface having a periodic pattern using a scanner, the periodic pattern having a first direction of periodicity having a periodic length, the scanner being configured to produce an image having a plurality of pixels, each of the pixels having a pixel origin, the scanner and the periodic pattern defining a reference error distance being a distance of a remainder of the periodic length over an integer number of the pixels when the first direction of periodicity of the periodic pattern is positioned parallel to a scanning direction of the scanner, the method comprising the steps of: (a) positioning the first direction of periodicity of the periodic pattern at an angle relative to the scanning direction of the scanner, the angle being chosen such that: (i) a first point of the periodic pattern is situated at the pixel origin of a first pixel; (ii) a second point of the periodic pattern is situated at a distance equal to the periodic length from the first point in a direction parallel to the first direction of periodicity; (iii) the second point is situated in a second pixel at a deviation distance from the pixel origin of the second pixel; and (iv) the deviation distance is less than the reference error distance; and (b) scanning the surface by generating relative movement between the scanner and the surface.

According to a further feature of the present invention, the deviation distance is substantially equal to zero.

According to a further feature of the present invention a cosine of the angle multiplied by the periodic length is substantially equal to an integer multiple of a dimension of the pixels parallel to the scanning direction.

According to a further feature of the present invention a sine of the angle multiplied by the periodic length is substantially equal to an integer multiple of a dimension of the pixels perpendicular to the scanning direction.

According to a further feature of the present invention a sine of the angle multiplied by the periodic length is substantially equal to an integer multiple of a dimension of the pixels perpendicular to the scanning direction.

According to a further feature of the present invention, there is also provided the step of processing the image by comparison of a best-matched pair of the pixels that are separated by a first integer multiple of the periodic length in a direction parallel to the first direction of periodicity.

According to a further feature of the present invention the first integer multiple is equal to one.

According to a further feature of the present invention, there is also provided the step of comparing one of the best-matched pair of the pixels to another best-match of the pixels that are separated by a second integer multiple of the periodic length in a direction parallel to the first direction of periodicity.

According to a further feature of the present invention the second integer multiple is equal to one.

According to a further feature of the present invention, the scanner includes at least one array of scanner pixels.

According to the teachings of the present invention there is provided a method to scan a surface having a periodic pattern using a scanner, the periodic pattern having a first direction of periodicity having a periodic length, the scanner being configured to produce an image having a plurality of pixels, the pixels having a pixel origin, the method comprising the steps of: (a) positioning the first direction of periodicity of the periodic pattern at an angle relative to a scanning direction of the scanner, the angle being chosen such that a sine of the angle multiplied by the periodic length is substantially equal to an integer multiple of a dimension of the pixels perpendicular to the scanning direction; and (b) scanning the surface by generating relative movement between the scanner and the surface along the scanning direction.

According to a further feature of the present invention a cosine of the angle multiplied by the periodic length is substantially equal to an integer multiple of a dimension of the pixels parallel to the scanning direction.

According to a further feature of the present invention, there is also provided the step of processing the image by comparison of a best-matched pair of the pixels that are separated by a first integer multiple of the periodic length in a direction parallel to the first direction of periodicity.

According to a further feature of the present invention the first integer multiple is equal to one.

According to a further feature of the present invention, there is also provided the step of comparing one of the best-matched pair of the pixels to another best-match of the pixels that are separated by a second integer multiple of the periodic length in a direction parallel to the first direction of periodicity.

According to a further feature of the present invention the second integer multiple is equal to one.

According to a further feature of the present invention, the scanner includes at least one array of scanner pixels.

According to a further feature of the present invention, there is also provided a method to scan a surface having a periodic pattern using a scanner, the periodic pattern having a first direction of periodicity having a periodic length, the scanner being configured to produce an image having a plurality of pixels, the pixels having a pixel origin, the method comprising the steps of: (a) positioning the first direction of periodicity of the periodic pattern at an angle relative to a scanning direction of the scanner, the angle being chosen such that a cosine of the angle multiplied by the periodic length is substantially equal to an integer multiple of a dimension of the pixels parallel to the scanning direction; and (b) scanning the surface by generating relative movement between the scanner and the surface along the scanning direction.

According to a further feature of the present invention a sine of the angle multiplied by the periodic length is substantially equal to an integer multiple of a dimension of the pixels perpendicular to the scanning direction.

According to a further feature of the present invention, there is also provided the step of processing the image by comparison of a best-matched pair of the pixels that are separated by a first integer multiple of the periodic length in a direction parallel to the first direction of periodicity.

According to a further feature of the present invention, the first integer multiple is equal to one.

According to a further feature of the present invention, there is also provided the step of comparing one of the best-matched pair of the pixels to another best-match of the pixels that are separated by a second integer multiple of the periodic length in a direction parallel to the first direction of periodicity.

According to a further feature of the present invention, the second integer multiple is equal to one.

According to a further feature of the present invention, the scanner includes at least one array of scanner pixels.

### BRIEF DESCRIPTION OF THE DRAWINGS

The invention is herein described, by way of example only, with reference to the accompanying drawings, wherein:

FIG. 1 a is a schematic plan view of an image of a scanned surface having a periodic pattern where the periodic length of the pattern is an integer multiple of the pixel size, that is constructed and operable in accordance with the prior art;

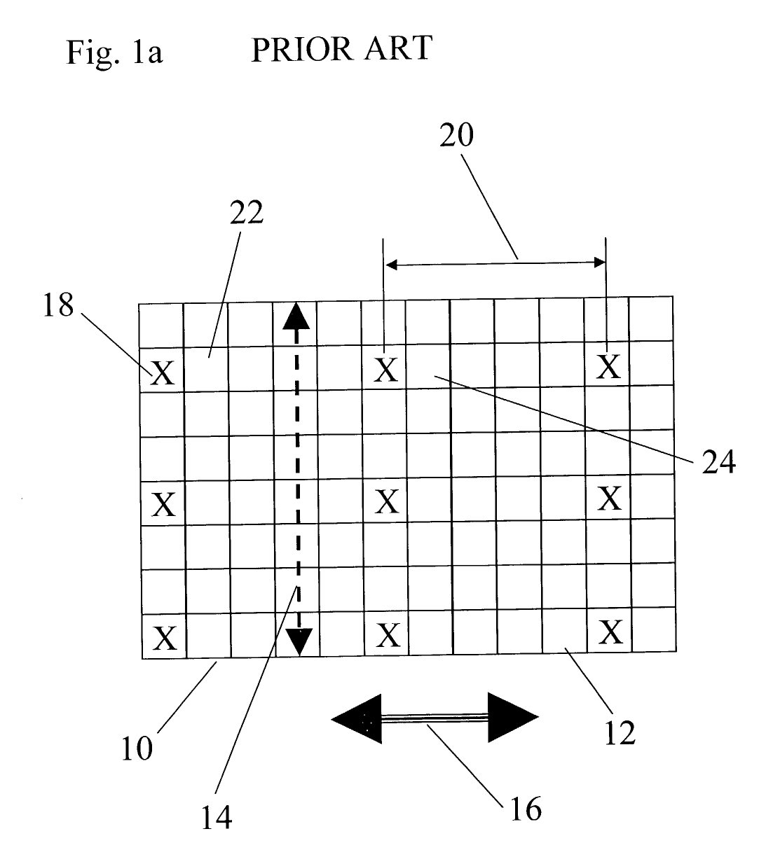

FIG. 1b is a schematic plan view of an image of a scanned surface having a periodic pattern where the periodic length of the pattern is not an integer multiple of the pixel size, that is constructed and operable in accordance with the prior art;

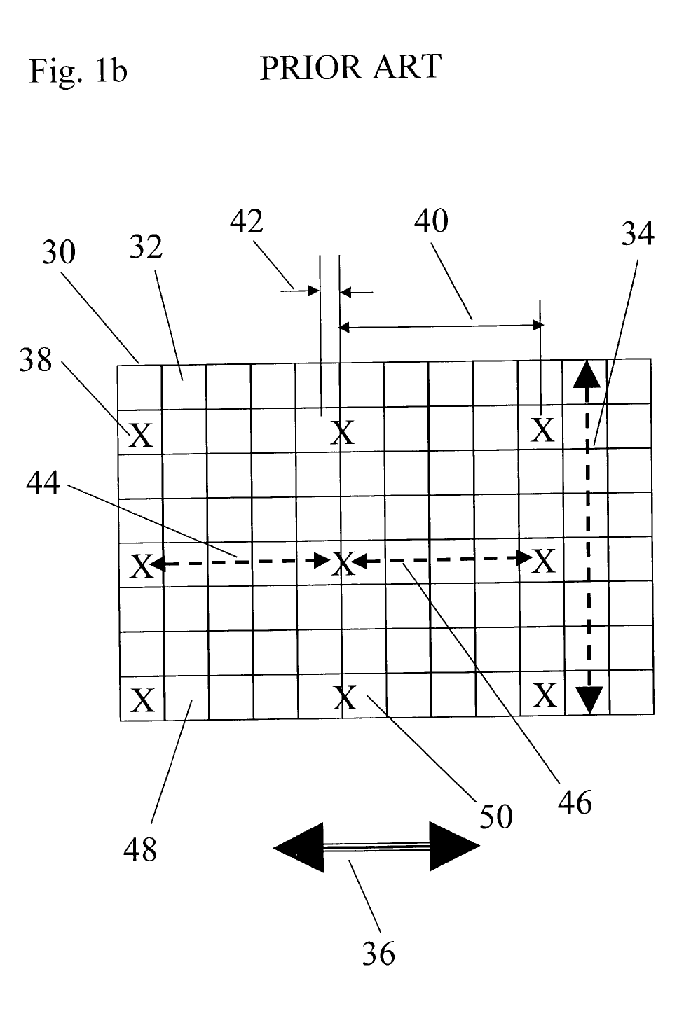

FIG. 2 is a schematic plan view of an image of a tilted scan that is constructed and operable in accordance with a preferred embodiment of the invention; and

FIG. 3 is an enlarged schematic plan view of a section of an image of a tilted scan that is constructed and operable in accordance with a preferred embodiment of the invention.

### DESCRIPTION OF THE PREFERRED EMBODIMENTS

The present invention is a method for comparing fragments of a pattern consisting of periodic fragments.

The principles and operation of the method for comparing fragments of a pattern consisting of periodic fragments according to the present invention may be better understood with reference to the drawings and the accompanying description.

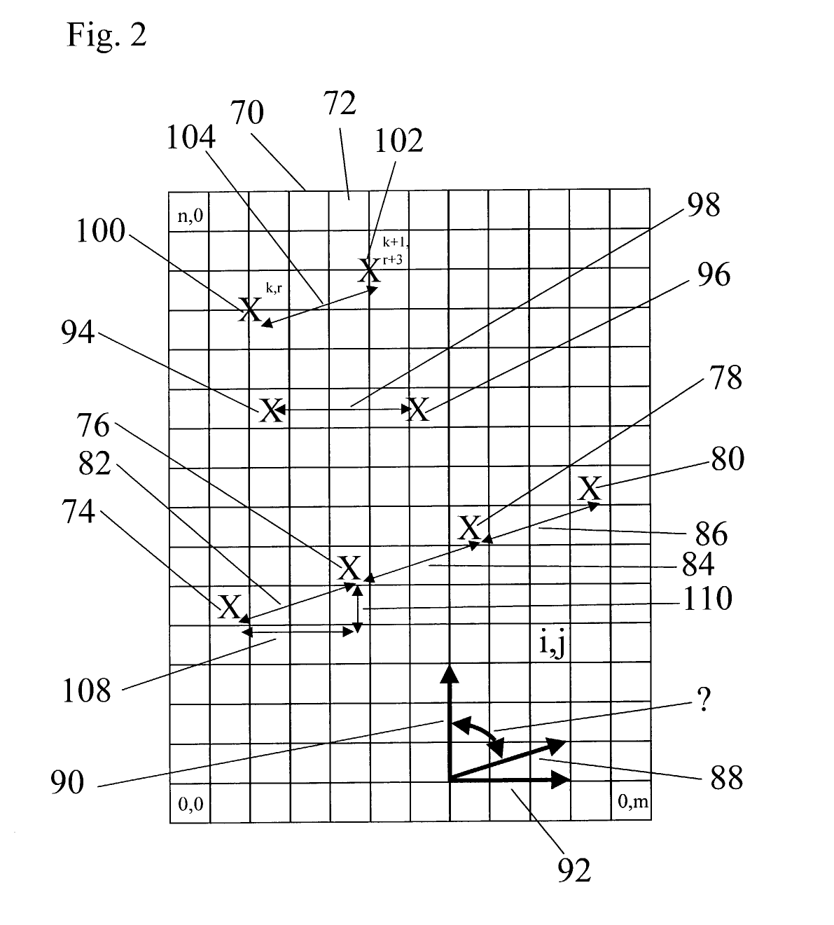

Reference is now made to FIG. 2, which is a schematic plan view of an image 70 of a tilted scan that is constructed and operable in accordance with a preferred embodiment of the invention. Image 70 is produced by a line-scanning camera, typically a TDI camera, by scanning a surface having a periodic pattern. The periodic pattern has at least one direction of periodicity.

Image 70 includes multiple pixels 72 arranged in a matrix form, the matrix having a size of m columns by n rows. Each pixel 72 has its registration index i,j where i is the number of rows from the origin of the matrix and j is the number of columns from the origin of the matrix. The matrix origin is at the lower left corner of the image and has the indices 0,0. Each pixel 72 has its own origin, a pixel origin, in the bottom left-hand corner therein. A cross 74 and a cross 76 represent the boundaries of a periodic fragment having periodic length 82 in a given direction of periodicity of the periodic pattern. Cross 76 and a cross 78 represent the boundaries of a periodic fragment having periodic length 84. Cross 78 and a cross 80 represent the boundaries of a periodic fragment having a periodic length 86. The periodic fragments form only part of a scanned pattern. The periodic fragments have a constant and identical periodic length p. It should be noted that arrows 82, 84 and 86 only represent the periodic length of fragments 82, 84 and 86 in the direction of periodicity of the periodic pattern and do not the fragments themselves. The fragments themselves have a pattern that is too complicated to show schematically.

An arrow 90 and an arrow 92 are primary axes representing the directions of increasing rows and increasing columns of the matrix respectively. Pixels 72 are aligned to primary axes 90, 92. A cross 94 and a cross 96 have a separation distance 98. Crosses 94, 96 and separation distance 98 are related to and have the same dimensions as crosses 74,76 and periodic length 82, respectively. Crosses 94, 96 and separation distance 98 are not a part of the scanned pattern and are shown only for the purpose of illustrating the relative position of crosses 74, 76 if the periodic direction of the fragments is aligned along primary axis 92. Similarly, a cross 100 and a cross 102 that have a separation distance 104, are also not a part of the scanned pattern and are shown only for the purpose of illustrating the relative position of crosses 74, 76 if the centers of crosses 74,76 coincide with the origins of pixels 72 of the matrix.

It is clearly seen that separation distance 98 between crosses 94, 96 which corresponds to periodic length 82 between crosses 74, 76, is not equal to the size of an integer number of pixels 72. Accordingly if the fragments of the scanned pattern, for example the fragment represented by periodic length 82, are aligned to primary axis 92 as illustrated by crosses 94, 96 a dramatic increase in the rate of false detection would be introduced to the inspection process of the scanned pattern.

Separation distance 104 between crosses 100, 102 that corresponds to periodic length 82 between crosses 74, 76 is not necessarily equal to the size of an integer number of pixels 72. However, separation distance 104 starts and ends at the same relative position relative to pixels 72 of image 70. Accordingly, when the fragments of the scanned pattern, are aligned in a direction 88 at an angle β relative to primary axis 90, it is possible to make a comparison between pixels (k, r) and (k+1, r+3) without increasing the rate of the false detection in the inspection process of the scanned surface. Pixels (k, r) and (k+1, r+3) are where separation distance 104 starts and ends, respectively.

Therefore, while comparison using the conventional comparison method is performed between pixels located in the same row or same column of the matrix, comparison in the method of the present invention is performed between pixels that do not belong to the same row or column. The scan direction according to the present invention is along primary axis 90 and the lines of the TDI camera are perpendicular to primary axis 90. Alternatively, the scan direction is along primary axis 92 and the lines of the TDI camera are perpendicular to primary axis 92. For a TDI camera, the relative speed between the camera and the pattern being scanned is adjusted such that during a cycle time-period of the camera the relative movement between the camera and the pattern being scanned is equal to the pixel size in the scan direction. The relative movement between the scanned surface and the TDI camera is introduced by moving the scanned surface, or by moving the camera, or by moving both of them.

The direction of the periodicity of the scanned pattern is aligned in direction 88 at angle β relative to primary axis 90 by rotating the scanned surface or by rotating the TDI camera. Periodic length 82 has a projected component 108 parallel to primary axis 92. Periodic length 82 has a projected component 110 parallel to primary axis 90. Therefore, projected component 108, projected component 110 and periodic length 82 are the sides of a right angled triangle and periodic length 82 being the hypotenuse thereof. Therefore, the mathematical expression for angle β is given by:

Angle β=Arc tangent (projected component 108/projected component 110) (equation 1).

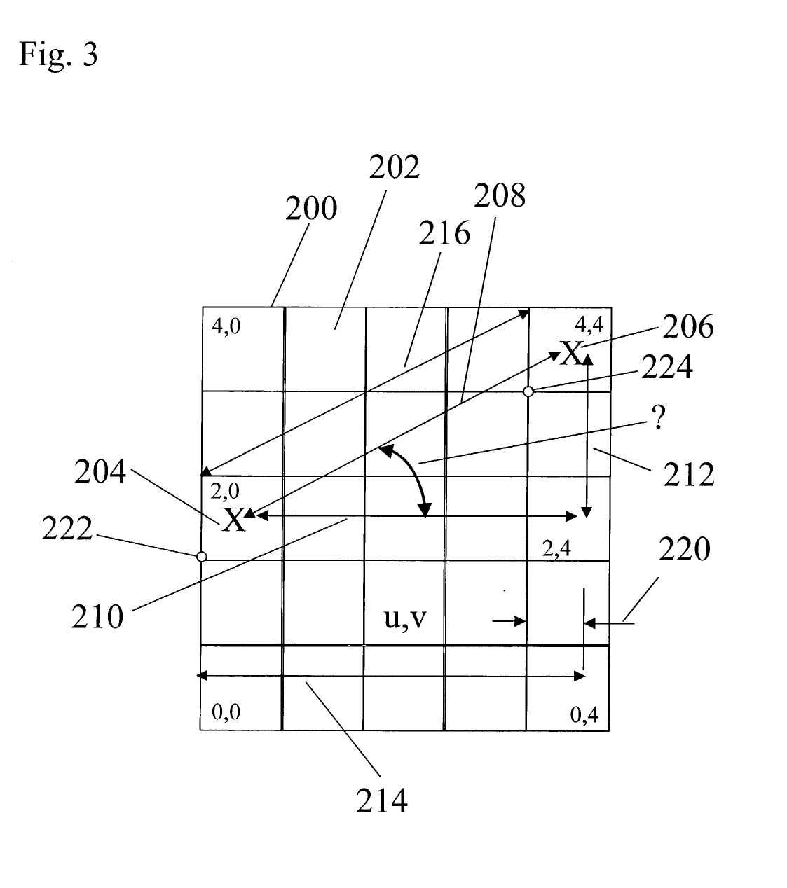

Reference is now made to FIG. 3, which is an enlarged schematic plan view of a section of an image 200 of a tilted scan that is constructed and operable in accordance with a preferred embodiment of the invention. As discussed with reference to FIG. 2, the optimal tilting angle of the scan depends on the pixel size and the periodic length of the fragments. Image 200 is acquired with a TDI camera. Image 200 includes multiple pixels 202 arranged in a matrix form. Each pixel 202 has its registration index u,v. The four corners of the matrix have the indices 0,0, 0,4, 4,0, and 4,4. A cross 204 and a cross 206 are located at pixels 2,0 and 4,4, respectively. Crosses 204, 206 define the boundaries of one fragment in the scanned pattern. The fragment has a periodic length 208. Periodic length 208 has a length size Z measured in units of pixel size. Periodic length 208 has a projected component 210 parallel to a first possible scanning direction. Periodic length 208 has a projected component 212 parallel to a second possible scanning direction. Component 210 has a length X measured in units of pixel size. Projected component 212 has a length Y measured in units of pixel size.

A length 214 has the same length Z as periodic length 208. Length 214 is aligned parallel to the matrix in the same way as the fragment associated with periodic length 208 would be aligned in a conventional scanning method that is used with a conventional comparison technique. It is clear, that the ends of length 214 do not have the same relative position with respect to pixels 202. The right end of length 214 is located in pixel 0,4. The left end of length 214 is located in pixel 0,0. The deviation of the position of the right end of length 214 within pixels 202 as compared to the position of the left end of length 214 within pixels 202 is given by a reference error distance 220. Therefore, according to the conventional comparison technique, pixels 0,0 and 0,4 should be compared. Since pixels 0,0 and 0,4 view different relative positions of the scanned fragments, their comparison would cause a dramatic increase in the false detection rate in the inspection process.

A periodic fragment, that is actually a displaced fragment that is identical to and parallel to the fragment associated with periodic length 208, has an associated periodic length 216. Therefore, periodic length 216 also has a length Z. The periodic fragment associated with periodic length 216 is brought here to emphasize that both of the ends of periodic length 216 have the same relative position with respect to pixels 202. Therefore, both of the ends of periodic length 208 have the same relative position with respect to pixels 202 when the direction of the periodicity of the fragments of the scanned pattern is aligned at an angle Ø to one of the possible scanning directions. Angle Ø is defined as the angle between projected component 210 and periodic length 208. In other words, angle Ø is chosen such that two conditions hold. Firstly, a cosine of angle Ø multiplied by periodic length 208 is substantially equal to an integer multiple of a dimension of pixels 202 parallel to the first possible scanning direction. Secondly, a sine of angle Ø multiplied by periodic length 208 is substantially equal to an integer multiple of a dimension of pixels 202 perpendicular to the first possible scanning direction. If pixels 202 are square, then the dimensions of pixels 202 perpendicular or parallel to the first possible scanning direction are the same. In general, the surface to be scanned is positioned so that the chosen direction of periodicity of the periodic pattern is at an angle relative to a chosen scanning direction of the scanner, the angle being chosen such that: (a) a first point of the periodic pattern is situated at the pixel origin of one of pixels 202; (b) a second point of the periodic pattern is situated at a distance equal to periodic length 208 from the first point in a direction parallel to the chosen direction of periodicity; (c) the second point is situated in a second pixel at a deviation distance from the pixel origin of the second pixel; and (d) the angle is chosen such that the deviation distance is as small as possible and is at least less than the reference error distance 220. The deviation distance ideally is equal to zero. Reference error distance 220 is generally given by the distance of a remainder of periodic length 208 over an integer number of pixels 202 when the chosen direction of periodicity of the periodic pattern is positioned parallel to the chosen scanning direction of the scanner. Accordingly pixels 2,0 and 4,4, which represent a best matched pair of pixels 202, are one of the pixel pairs that are compared according to the present invention. In general, the best-matched pair of pixels 202 are separated by a first integer multiple of the periodic length 208 in a direction parallel to the chosen direction of periodicity. In other words, a measurement equal to an integer multiple of periodic length 208 is made in a direction parallel to the chosen direction of periodicity from the center of one of pixels 202, being the first of the best-matched pair of pixels 202. The destination point of the measurement is in a pixel that is the second pixel of the best-matched pair of pixels 202. As previously discussed, in relation to three-fragment comparison, one fragment is typically compared to another two fragments. Therefore, one of the best-matched pair of pixels 202 is compared to another best match of pixels 202. This second pair are separated by a second integer multiple of periodic length 208 in a direction parallel to the first direction of periodicity. The best-match pairs of pixels 202 are typically in adjacent fragments and therefore first integer multiple and second integer multiple are typically equal to one.

The example shown in FIG. 3, demonstrates an ideal situation with respect to the present invention where projected component 210 and projected component 212 having sizes X and Y, respectively, are equal to the size of an integer number of pixels and the ends of periodic length 208 are located exactly at the same relative position with respect to pixels 202. In other words, the distance from a point 222 at the origin of pixel 2,0 to cross 204 is the same as the distance from a point 224 at the origin of pixel 4,4 to cross 206.

Accordingly, in this situation the advantages of the present invention over the conventional scanning and comparing techniques are readily apparent. Nevertheless, the following analysis shows that the present invention is still superior to the conventional techniques even for non-ideal situations.

As discussed with reference to FIG. 3, periodic length 208 has a length Z, which is the length of an ideal fragment where the edges of the fragment are located exactly at the same relative position with respect to pixels 202. However, for a non-ideal situation the fragment length is given by (Z+ΔZ). ΔZ is the deviation from the length Z of the ideal fragment. A deviation length ΔX and a deviation length ΔY are the deviations from the lengths X and Y respectively, where X and Y are the projected components onto the two possible scanning directions of an ideal fragment having a length Z. Therefore (X+ΔX) and (Y+ΔY) are the projected components onto the two possible scanning directions of the non-ideal fragment having a length (Z+ΔZ). The lengths X, Y, Z, ΔX, ΔY and ΔZ are measured in units of pixel size and the lengths of X and Y are an integer number of the pixel size. The length (Z+ΔZ) of the scanned fragment is a given size that cannot be controlled. The values of (X+ΔX) and (Y+ΔY) depend on the chosen angle of the tilted scan. In a case when both (Z+ΔZ) and the pixel size are fixed and only the tilted angle of the scan can be adjusted, it is impossible to assure that both ΔX and ΔY will be always equal to zero. It is still possible to find a whole family of values of tilted-scanning angles where:

Angle Ø=arc cosine (X/(Z+ΔZ) when ΔX=0; or

Angle Ø=arc sine (Y/(Z+ΔZ) when ΔY=0.

Pythagoras' theorem gives the following:

(X+ΔX)²+(Y+ΔY)²=(Z+ΔZ)² (equation 2).

For example, it is reasonable to assume that ΔX=0 and therefore equation 2 becomes:

(X)²+(Y+ΔY)²=(Z+ΔZ)² (equation 3).

Equation 3 can be rewritten as follows:

[(Z+ΔZ)²−(X)²]^{1/2}−Y=ΔY (equation 4).

Equation 4 can be written as follows:

(Z+ΔZ){1+[X/(Z+ΔZ)]2}^{1/2}−Y=ΔY (equation 5).

Since X can be chosen to be much less than Z, we can use the approximation of Newton's Binomial Theorem giving:

(Z+ΔZ){1 +1/2[X/(Z+ΔZ)]2}−Y=ΔY (equation 6).

X can be changed by increment steps of one pixel size and thus ΔY is changed by increment step Δ(ΔY) given by:

Δ(ΔY)=(Z+ΔZ){1+½[(X+1)/(Z+ΔZ)]²}−Y−(Z+ΔZ){1+½[X/(Z+ΔZ)]²}−Y=(X+½)/(Z+ΔZ) (equation 7).

Since X is considerably less than Z then the increment step Δ(ΔY) in which ΔY can be changed satisfies the condition that Δ(ΔY) is considerably less than 1. For example, the typical value for Z is about 50 and a typical value for X is about 2, thus the typical value for the increment step Δ(ΔY) of ΔY is about 0.04. This means that fine-tuning of ΔY is possible by increment steps Δ(ΔY) of about 0.04 of the pixel size.

Since ΔX=0, the relevant deviation for the comparison method is ΔY. In the conventional comparison method the maximum deviation is half a pixel size and the average deviation is 0.25 of a pixel size. In the present invention the maximum deviation is at the size of one increment step and the average size of the deviation is half an increment step, an increment step being 0.02 of a pixel size. Accordingly, it is clear that the present invention will cause a dramatic decrease in the false detection rate when compared to the conventional comparison method.

It should be noted that although in the above discussion, ΔX is assumed to be zero and ΔY is assumed to vary, the surface under inspection can be positioned such that ΔY is zero and ΔX varies.

It should be noted that in the examples of FIG. 2 and FIG. 3, the pixels are shown as being square. However, it should be noted that the teachings of the present invention apply equally to pixels that are rectangular, having a different length and width.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art which would occur to persons skilled in the art upon reading the foregoing description. For example, a TDI camera can be replaced by other cameras such as a line-scan camera or CCD camera. Although the invention has been described using the example of scanning silicon wafers, the invention can be used for many other applications such as inspecting Printed Circuits Boards (PCB), projecting masks or any other surface having periodic pattern.

What is claimed is:

1. A method to scan a surface having a periodic pattern using a scanner, the periodic pattern having a first direction of periodicity having a periodic length, the scanner being configured to produce an image having a plurality of pixels, each of the pixels having a pixel origin, the scanner and the periodic pattern defining a reference error distance being a distance of a remainder of the periodic length over an integer number of the pixels when the first direction of periodicity of the periodic pattern is positioned parallel to a scanning direction of the scanner, the method comprising the steps of:
(a) positioning the first direction of periodicity of the periodic pattern at an angle relative to the scanning direction of the scanner, said angle being chosen such that:
(i) a first point of the periodic pattern is situated at the pixel origin of a first pixel;
(ii) a second point of the periodic pattern is situated at a distance equal to the periodic length from said first point in a direction parallel to the first direction of periodicity;
(iii) said second point is situated in a second pixel at a deviation distance from the pixel origin of said second pixel; and
(iv) said deviation distance is less than the reference error distance; and
(b) scanning the surface by generating relative movement between the scanner and the surface.

2. The method of claim 1 wherein said deviation distance is substantially equal to zero.

3. The method of claim 1 wherein a cosine of said angle multiplied by said periodic length is substantially equal to an integer multiple of a dimension of the pixels parallel to the scanning direction.

4. The method of claim 3 wherein a sine of said angle multiplied by said periodic length is substantially equal to an integer multiple of a dimension of the pixels perpendicular to the scanning direction.

5. The method of claim 1 wherein a sine of said angle multiplied by said periodic length is substantially equal to an integer multiple of a dimension of the pixels perpendicular to the scanning direction.

6. The method of claim 1 further comprising the step of processing the image by comparison of a best-matched pair of the pixels that are separated by a first integer multiple of the periodic length in a direction parallel to the first direction of periodicity.

7. The method of claim 6 wherein said first integer multiple is equal to one.

8. The method of claim 6 further comprising the step of comparing one of said best-matched pair of the pixels to another best-match of the pixels that are separated by a second integer multiple of the periodic length in a direction parallel to the first direction of periodicity.

9. The method of claim 8 wherein said second integer multiple is equal to one.

10. The method of claim 1 wherein the scanner includes at least one array of scanner pixels.

11. A method to scan a surface having a periodic pattern using a scanner, the periodic pattern having a first direction of periodicity having a periodic length, the scanner being configured to produce an image having a plurality of pixels, the pixels having a pixel origin, the method comprising the steps of:
(a) positioning the first direction of periodicity of the periodic pattern at an angle relative to a scanning direction of the scanner, said angle being chosen such that a sine of said angle multiplied by said periodic length is substantially equal to an integer multiple of a dimension of the pixels perpendicular to said scanning direction; and
(b) scanning the surface by generating relative movement between the scanner and the surface along said scanning direction.

12. The method of claim 11 wherein a cosine of said angle multiplied by said periodic length is substantially equal to an integer multiple of a dimension of the pixels parallel to said scanning direction.

13. The method of claim 11 further comprising the step of processing the image by comparison of a best-matched pair of the pixels that are separated by a first integer multiple of the periodic length in a direction parallel to the first direction of periodicity.

14. The method of claim 13 wherein said first integer multiple is equal to one.

15. The method of claim 12 further comprising the step of comparing one of said best-matched pair of the pixels to another best-match of the pixels that are separated by a second integer multiple of the periodic length in a direction parallel to the first direction of periodicity.

16. The method of claim 15 wherein said second integer multiple is equal to one.

17. The method of claim 11 wherein the scanner includes at least one array of scanner pixels.

18. A method to scan a surface having a periodic pattern using a scanner, the periodic pattern having a first direction of periodicity having a periodic length, the scanner being configured to produce an image having a plurality of pixels, the pixels having a pixel origin, the method comprising the steps of:
(a) positioning the first direction of periodicity of the periodic pattern at an angle relative to a scanning direction of the scanner, said angle being chosen such that a cosine of said angle multiplied by said periodic length is substantially equal to an integer multiple of a dimension of the pixels parallel to said scanning direction; and
(b) scanning the surface by generating relative movement between the scanner and the surface along said scanning direction.

19. The method of claim 18 wherein a sine of said angle multiplied by said periodic length is substantially equal to an integer multiple of a dimension of the pixels perpendicular to said scanning direction.

20. The method of claim 18 further comprising the step of processing the image by comparison of a best-matched pair of the pixels that are separated by a first integer multiple of the periodic length in a direction parallel to the first direction of periodicity.

21. The method of claim 20 wherein said first integer multiple is equal to one.

22. The method of claim 20 further comprising the step of comparing one of said best-matched pair of the pixels to another best-match of the pixels that are separated by a second integer multiple of the periodic length in a direction parallel to the first direction of periodicity.

23. The method of claim 22 wherein said second integer multiple is equal to one.

24. The method of claim 18 wherein the scanner includes at least one array of scanner pixels.
